(19) United States
(12) Patent Application Publication
(10) Pub. No.: US 2023/0243404 A1
(43) Pub. Date: Aug. 3, 2023

(54) Drive system comprising at least two drive units, in particular for applications with a high rotational speed

(71) Applicant: RENK GmbH, Augsburg (DE)

(72) Inventor: Peter Boiger, Augsburg (DE)

(73) Assignee: RENK GmbH, Augsburg (DE)

(21) Appl. No.: 18/004,223

(22) PCT Filed: Jun. 14, 2021
(86) PCT No.: PCT/EP2021/065901

§ 371 Date: Jan. 4, 2023

(30) Foreign Application Priority Data
Jul. 10, 2020 (DE) 10 2020 118 248.1

(51) Int. Cl. F16H 1/22; F16H 57/02

(52) U.S. Cl. CPC F16H 1/22; F16H 57/02; F16H 2057/02034

(57) ABSTRACT

A drive system has at least two drive units each including a central shaft, a central gear wheel connected to the central shaft such that the central gear wheel rotates at a speed of the central shaft, and two to four decentralized gear wheels distributed over the circumference of the central gear wheel and meshing with the central gear wheel such that the speed of the central gear wheel is at least 0.5 times the speed of the decentralized gear wheels. The rotational speed of the central gear wheel is at least 0.5 times the rotational speed of the decentralized gear wheels. Each decentralized gear wheel is coupled directly and without transmission to a single electric machine, or to two electric machines of a plurality of electric machines. The central shafts of the drive units are coupled to form a series connection of the drive units.

### CROSS-REFERENCE TO RELATED APPLICATIONS

This application is a national phase application under 35 U.S.C. § 371 of International Patent Application No. PCT/EP2021/065901, filed Jun. 14, 2021 (pending), which claims the benefit of priority to German Patent Application No. DE 10 2020 118 248.1, filed Jul. 10, 2020, and is related to U.S. patent application Ser. No. ______ (Attorney Docket No. WALR-85), filed Jan. 4, 2023, the disclosures of which are incorporated by reference herein in their entirety.

### TECHNICAL FIELD

The invention relates to a drive system particularly for high-speed applications.

### BACKGROUND

Drive systems known from practice, which interact in particular with fluid machinery such as turbines and compressors, and which transmit drive powers of more than 1 MW, preferably more than 2.5 MW, in particular drive powers between 1 MW and 10 MW, preferably between 2.5 MW and 10 MW, require a lot of installation space, are heavy and expensive. This applies both to drive systems which transmit power provided by a turbine in the direction of a generator and to drive systems which, starting from an electric machine, transmit drive power in the direction of a compressor or in the direction of a centrifugal pump.

There is therefore a need for a drive system that requires relatively little installation space, is relatively lightweight and cost-effective, even when transmitting drive powers of more than 1 MW.

### SUMMARY

Based on this, it is on object of the present invention to provide a novel drive system.

This task is solved by a drive system as described herein.

The drive system comprises at least two drive units.

Each of the drive units of the drive system comprises the following: A central shaft. A central gear wheel connected to the central shaft in such a way that the central gear wheel rotates at a speed of the central shaft. At least two and at most four, that is, two or three or four, decentralized gears distributed around the circumference of the central gear and meshing with the central gear such that the rotational speed of the central gear is at least 0.5 times the rotational speed of the decentralized gears. A plurality of electric machines, each decentralized gear being directly coupled to a single electric machine or to two electric machines, respectively, without transmission. The central shafts of the at least two drive units of the drive system according to the invention are coupled forming a series connection of the drive units. Accordingly, the central shafts of the at least two drive units coupled in series form a central shaft of the drive system and rotate at the same speed.

The drive system according to the invention comprises, for each drive unit, the central shaft, the central gearwheel rotating with the central shaft, the decentralized gearwheels and the electric machines, which are coupled directly and without transmission with the decentralized gearwheels. The decentralized gearwheels of each drive unit mesh with the central gearwheel of the respective drive unit in such a way that the rotational speed of the central gearwheel is at least 0.5 times the rotational speed of the decentralized gearwheels, which rotate at the same speed as the electric machines of the respective drive unit.

In conventional gearbox arrangements, series connection cannot be made because conventional gearboxes have one or more parallel drives and have an output or vice versa. Such arrangements cannot be connected or used in series. Because the central shaft of the drive units of the drive system according to the invention can be coupled on both sides, a series arrangement becomes possible.

On the one hand, modularization of the drive system into the at least two drive units and, on the other hand, modularization of the drive units into the multiple electric machines and the multiple decentralized gears is proposed.

This modularity of the drive system as well as the modularity of the drive units can save installation space, costs and weight compared to conventional drive systems.

All drive units are identical to each other. Within a drive unit, the decentralized gears and the electrical machines are identical.

Each of the drive units further comprises associated bearings for the central shaft and the decentralized shafts. Furthermore, each of the drive units comprises an, in particular oil-carrying, housing. Within a drive unit, the bearings are also identical.

The drive system according to the invention can make use of commercially available and inexpensive electrical machines and can therefore be implemented at relatively low cost. Furthermore, such a drive system is relatively lightweight and requires little installation space. It is thus possible to make use of relatively compact, lightweight and inexpensive standard components in the construction of a drive system which provides a drive power of at least 1 MW, in particular of at least 2 MW, preferably of at least 5 MW. Instead of a special design, common series components of small partial outputs are combined to a total output corresponding to the drive task.

According to a further development of the invention, the electric machines of the drive units can be operated at a speed of at least 4,000 rpm. Accordingly, the central shafts of the drive units coupled in series are operable at a speed of at least 2,000 rpm. A drive system in which the coupled central shafts of the drive units coupled in series rotate at a speed of at least 2,000 rpm is a drive system for high-speed applications.

Preferably, the decentralized gearwheels of the drive units are meshing with the central gearwheel of the respective drive unit in such a way that the rotational speed of the central gearwheel is between 0.5 and 4.0 times, preferably between 0.8 and 3.0 times, particularly preferably more than 1.0 times and at most 2.5 times, the rotational speed of the decentralized gearwheels.

It should be noted that combinations of the above subranges are also included, such that the rotational speed of the central gear of the respective drive unit is in particular between 0.5 times and 3.0 times, between 0.5 times and 2.5 times, between 0.8 times and 4.0 times, between 0.8 times and 2.5 times, more than 1.0 times and at most 4.0 times, more than 1.0 times and at most 3.0 times, between 2.5 times and 4.0 times or also between 3.0 times and 4.0 times the rotational speed of the decentralized gear wheels of the respective drive unit.

Then, when the central gearwheel of the respective drive unit rotates faster than the decentralized gearwheels and thus the electric machines of the respective drive unit, the drive system or in which the electric machines as electric motors transmit drive power in the direction of, for example, a compressor, provides a transmission to the faster. For this application in particular, a drive system for driving a compressor can be provided at particularly low cost, with particularly low weight and particularly small installation space, starting from several identical electric machines.

Preferably, the electric machines of the drive units are drive motors which drive the decentralized gears, the central shafts of the drive units connected in series forming a central output shaft of the drive system, to which a unit to be driven can be coupled, preferably a compressor or a centrifugal pump.

Alternatively, the electric machines of the drive units are generators, which can be driven via the decentralized gear wheels, with the central shafts of the drive units connected in series forming a central drive shaft of the drive system, to which a turbine can preferably be coupled as the drive unit.

Particularly preferably, the invention is used when the electric machines serve as drive units to drive a unit to be driven, such as a compressor or a centrifugal pump, which is coupled to the central shafts of the drive units in series. In this case, a transmission between the decentralized gearwheels and the central gearwheel is designed in such a way that, starting from the electric machines, a transmission into the faster direction takes place, so that the central gearwheel of the respective drive unit rotates at a higher speed than the electric machines of the respective drive unit. Thus, in the case of electric machines that are operated at a speed of at least 4,000 rpm, a speed of, for example, 16,000 rpm can be provided at the central shaft and thus at the unit to be driven.

The electrical machines of the drive units are preferably electrical machines with a frequency converter, which are designed in particular as synchronous machines with a frequency converter. By adjusting the frequency of the frequency converter, output speeds of the electrical machines can be varied at nominal conditions.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 depicts a side view of a drive unit of a drive system in accordance with the present disclosure;

FIG. 2 depicts a perspective view of the drive unit FIG. 1 with partially disassembled electrical machines;

FIG. 3 is a detail view of the drive unit of FIGS. 1, 2 in the area of the attachment of one of the electrical machines;

FIG. 4 is an end view of the drive unit of FIG. 1 and;

FIG. 5 is a detail view of the drive unit of FIGS. 1, 2 in the area of a decentralized gear wheel and two electric machines;

FIG. 6 depicts a perspective view of an exemplary drive system with three drive units coupled in series; and

FIG. 7 is a side view of the drive system of FIG. 6.

### DETAILED DESCRIPTION

The invention relates to a drive system comprising at least two drive units. The plurality of drive units are identical to each other.

The drive system according to the invention is preferably used in conjunction with turbomachinery, either to transmit motor drive power from electric machines designed as drive motors in the direction of a compressor, or to transmit mechanical drive power from a turbine in the direction of electric machines designed as generators.

The drive power to be transmitted is more than 2 MW, preferably more than 5 MW, preferably between 5 MW and 10 MW.

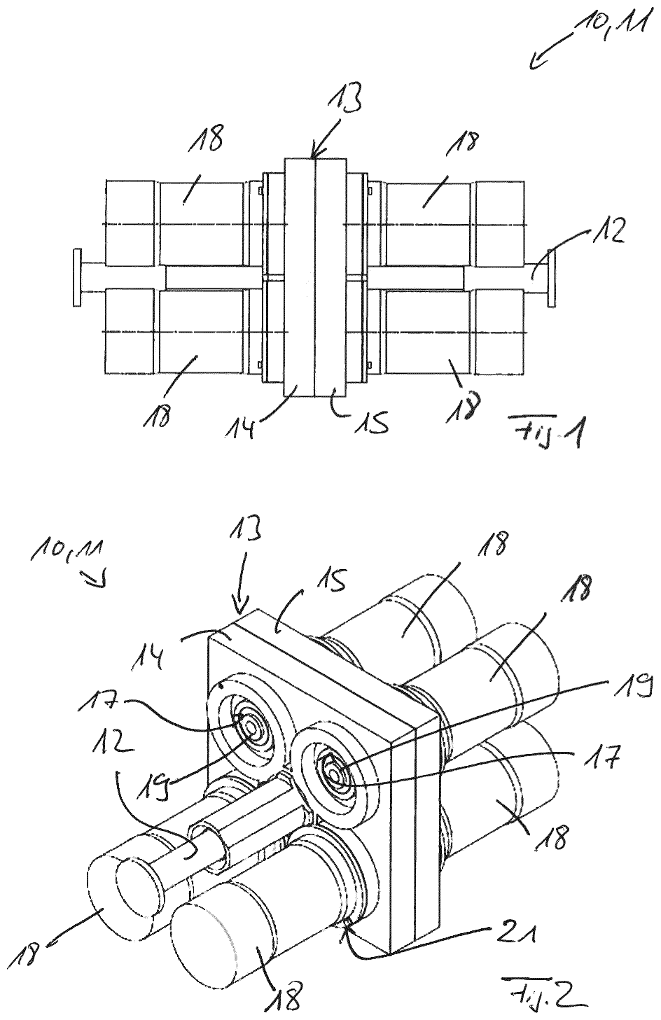

FIGS. 1 to 4 show schematized different views and details of a drive unit 11 of a drive system 10. The drive system 10 according to the invention comprises at least two drive units 11, which are identical to each other.

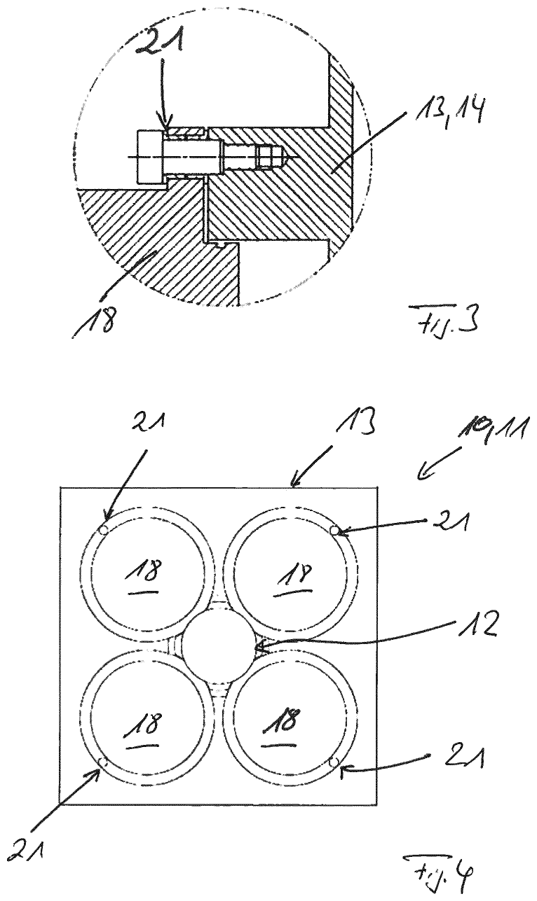

Each drive unit 11 comprises a central shaft 12. The central shaft 12 is rotatably mounted in a housing 13 of the drive unit 11. According to FIGS. 1, 2, the housing 13 is divided into two housing halves 14, 15.

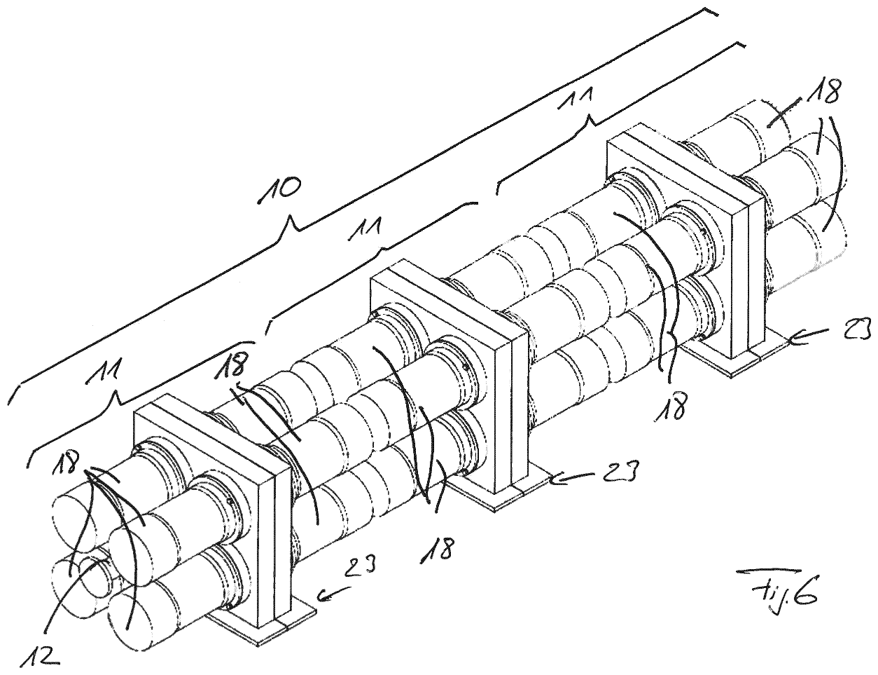

Each drive unit 11 of the drive system 10 further comprises a central gear wheel 16 (see FIG. 5), which is connected to the central shaft 12 and rotates together with the central shaft 12. The central gear wheel 16 is directly connected to the central shaft 12 without transmission.

Each drive unit 11 of the drive system 10 further comprises at least two and at most four, i.e. two, three or four, decentralized gear wheels 17, which are preferably uniformly distributed over the circumference of the central gear wheel 16 and are in mesh with the central gear wheel 16, such that the rotational speed of the central gear wheel 16 is at least 0.5 times the rotational speed of the decentralized gear wheels 17. Four decentralized gear wheels 17 uniformly distributed over the circumference of the central gear wheel 16 are preferred.

Preferably, the decentralized gears 17 mesh with the central gear 16 in such a way that the speed of the central gear 16 is at least 0.8 times, and more preferably more than 1.0 times, the speed of the decentralized gears 17.

Preferably, it is provided that the decentralized gear wheels 17 of each drive unit 11 mesh with the central gear wheel 16 of the respective drive unit 11 in such a way that the rotational speed of the central gear wheel 16 is between 0.5 and 4.0 times, preferably between 0.8 and 3.0 times, particularly preferably more than 1.0 times and at most 2.5 times, the rotational speed of the decentralized gear wheels 17.

It should be noted that combinations of these above subranges are also included, such that the speed of rotation of the central gear 16 of each drive unit 11 is in particular between 0.5 times and 3.0 times, between 0.5 times and 2.5 times, between 0.8 times and 4.0 times, between 0,8 times and 2.5 times, more than 1.0 times and at most 4.0 times, more than 1.0 times and at most 3.0 times, between 2.5 times and 4.0 times or also between 3.0 times and 4.0 times the rotational speed of the decentralized gear wheels 17 of the respective drive unit 11.

The decentralized gear wheels 17 of each drive unit 11 of the drive system 10 mesh directly or immediately with the central gear wheel 16 of the respective drive unit 11. The respective decentralized gear wheels 17 therefore mesh with the respective central gear wheel 16 without the interposition of further gear wheels.

Each drive unit 11 of the drive system 10 further comprises several, namely at least two and at most eight, electric machines 18. Each decentralized gear wheel 17 is coupled directly and without transmission to a single electric machine 18 or, as shown in the embodiment example of FIGS. 1 to 4, to two electric machines 18. The speed of the electric machines 18 corresponds to the speed of the decentralized gearwheels 17.

FIG. 5 shows a detail of the drive unit 11 in the area of a decentralized gear wheel 17, which is coupled directly and without transmission ratio to two electric machines 18. The decentralized gear wheel 17, which is shown in FIG. 5, is connected to a shaft 19, which is coupled at both ends directly and without transmission ratio to a respective electric machine 18. This shaft 19 is rotatably mounted in the housing 13, namely via bearings 20.

The electric machines 18 of the drive units 11 preferably rotate at a speed of at least 4,000 rpm. The speed of rotation of the central shafts 12 of the drive units 11 is preferably at least 2,000 rpm.

Then, when the electric machines 18 of the drive units 11 have a speed of 4,000 rpm and a gear ratio between the decentralized gears 17 and the central gear 16 of the drive units 11 is 4.0, the speed of the central shafts 12 of the drive units 11 is 16,000 rpm. At a gear ratio of 4.0, the rotational speed of the central gear wheel 16 and thus of the central 12 shaft corresponds to 4.0 times the rotational speed of the decentralized gear wheels 17 and thus of the electric machines 18. At higher rotational speeds of the electric machines 18, higher rotational speeds can of course be realized at the central shaft 16.

In particular, the electric machines 18 can provide or absorb power of up to 500 kW. Preferably, the power of each of the electric machines 18 is between 100 kW and 500 kW. The electric machines 18 may also have power ratings in excess of 500 kW.

For example, if the power of an electric machine is 100 KW, the total power of the drive unit 11 shown in FIGS. 1 to 4, which has eight identical electric machines 18, is 0.8 MW. If the power of an electric machine is, for example, 300 KW, the total power of the drive unit 11 shown in FIGS. 1 to 4, which has eight identical electric machines 18, is 2.4 MW.

The drive system 10 according to the invention comprises at least two drive units 11 connected in series. If each drive unit has a power of 0.8 MW, four drive units 11 connected in series can provide the drive system 10 with a power of 3.2 MW. If each drive unit 11 has 2.4 MW of power, three drive units 11 connected in series can provide the drive system 10 with 7.2 MW of power.

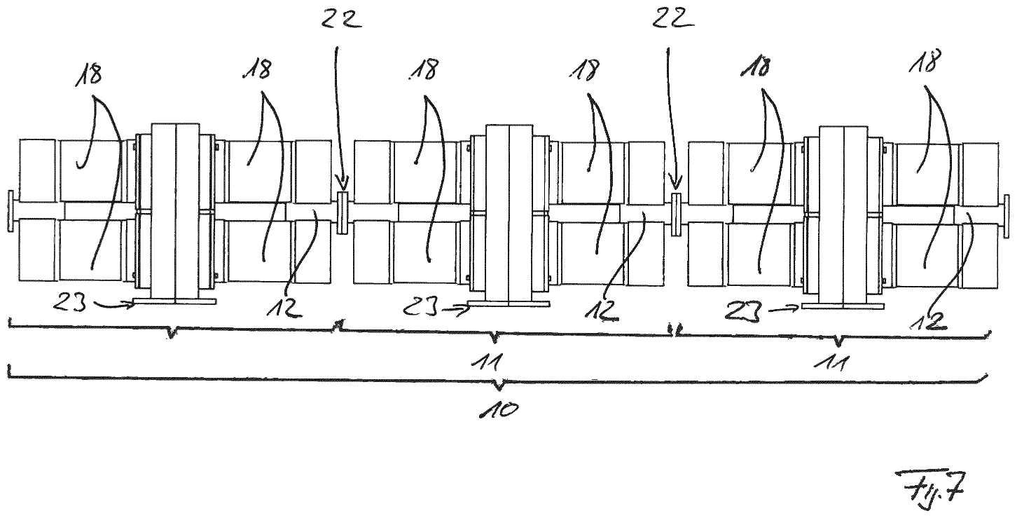

FIGS. 6 and 7 show a drive system 10 with three drive units 11 connected in series. According to FIG. 7, the central shafts 12 of the drive units 11 connected in series are coupled via couplings 22.

The couplings 22 may be switchable couplings 22 or preferably fixed, non-switchable couplings 22.

The couplings 22 may be surrounded by a coupling shroud having oil drain holes.

In FIGS. 6 and 7, a mounting block 23 or its mounting block 23 and a lubricating oil supply and/or cooling oil supply for the respective drive unit 11 are arranged under each housing 13 of the respective drive unit 11.

Preferably, a shaft of each electric machine 18 of each drive unit 11 is directly coupled to the respective decentralized gear 17, namely to the shaft 19 carrying the respective decentralized gear 17, the respective electric machine 18 being fixed to the housing 13 of the respective drive unit 11.

Each drive unit 11 preferably comprises two central bearings for the central shaft 12, comprising at least radial bearings. In the case of an odd number of drive units 11, the central bearings also comprise a thrust bearing for the central shaft 12.

The central bearings of the respective drive unit 11 are supported via the respective mounting block 23 of the respective drive unit 11.

As already explained, each shaft 19 connected to a decentralized gear 17 is rotatably supported in the housing 13 via the bearings 20. The bearings 20 include at least radial bearings and possibly also thrust bearings. The electric machines 18 are preferably coupled to the shaft 19 via plug-in gears.

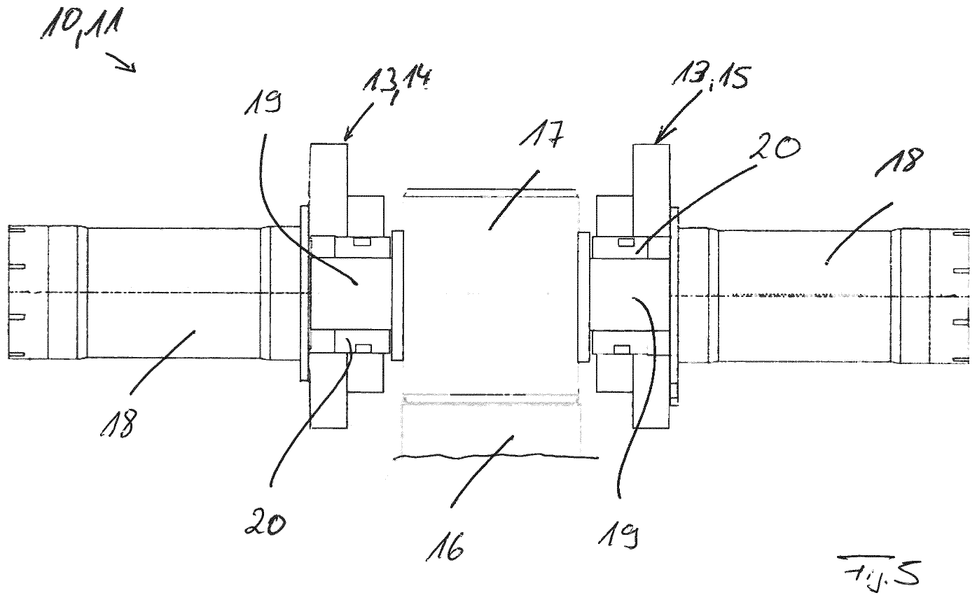

According to FIG. 3, the electric machines 18 are connected to the housing 13 of the drive unit 11 via bushings 21. The electric machines 18 can be easily mounted and dismounted, namely in horizontal direction.

As already explained, the housing 13 of each drive unit 11 is divided, namely vertically. Horizontal separation is also possible.

In a first variant, it is provided that the electric machines 18 of the drive units 11 coupled in series are drive motors which drive the decentralized gears 17 without transmission. In this case, the decentralized gears 17 of the drive units 11 then drive the respective central gears 16 and the respective central shafts 12, wherein a unit to be driven, preferably a compressor or a centrifugal pump, is coupled to the series-coupled central shafts 12 of the drive units 11. The coupled central shafts 12 of the drive units 11 coupled in series then form a central output shaft of the drive system 10.

In a second variant, it is provided that the electrical machines 18 of the drive units 11 coupled in series are generators which are driven via the decentralized gear wheels 17. In this case, a drive unit is coupled to the series-coupled central shafts 12 of the drive units 11, which drives the central shafts 12, the central gears 16 via the central shafts 12, the decentralized gears 17 in mesh with the respective central gear 16 via the central gears 16, and thus ultimately the electric machines 18 serving as generators. As a drive unit, a turbine is then preferably coupled to the series-coupled central shafts 12 of the series-coupled drive units 11. The coupled central shafts 12 of the drive units 11 coupled in series then form a central drive shaft of the drive system 10.

The drive system 10 is characterized by a high degree of modularity. The drive system 10 comprises a plurality of drive units 11. The plurality of drive units 11 are identical in design to one another.

Each drive unit 11 comprises the central shaft 12, the central gear wheel 16 and two or three or four decentralized gear wheels 17, which mesh with the central gear wheel 16 and are coupled directly and without transmission ratio to one or two electric machines 18 respectively. The electric machines 18 of each drive unit 11 are identical. The decentralized gear wheels 17 are also identical and preferably uniformly distributed around the circumference of the central gear wheel 16.

With access to simple, standardized components, a low-cost, lightweight drive system requiring little installation space can thus be provided with high performance of the drive system 10.

The electric machines 18 of the drive units 11 have a frequency converter. By adjusting the frequency of the frequency converters, output speeds of the electric machines 18 can be easily varied within a range of 4,000 to 9,000 rpm at rated conditions. Since different output speeds of the electrical machines 18 are available, the same drive system can be used for a wide range of applications with identical drive system design. Since project-specific adaptations generate costs that are incurred again with each subsequent project, this creates further potential for savings. Preferably, the electrical machines 18 are operated in a so-called corner point thereof. Operation of the electrical machines 18 below and above the corner point is also possible.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described.

1-11. (canceled)

12. A drive system, comprising:
at least two drive units, each drive unit respectively comprising:
a central shaft,
a central gear connected to the central shaft such that the central gear rotates at a rotational speed of the central shaft,
two or three or four decentralized gears distributed around a circumference of the central gear and meshing with the central gear such that the rotational speed of the central gear is at least 0.5 times the rotational speed of the decentralized gears, and
a plurality of electric machines, wherein each decentralized gear wheel is coupled directly and without transmission to a single electric machine or to two electric machines;
wherein the central shafts of the drive units are coupled to form a series connection of the drive units.

13. The drive system of claim 12, wherein the drive units are identical.

14. The drive system of claim 12, wherein the electric machines and the decentralized gears of each drive unit are identical.

15. The drive system of claim 12, wherein the electric machines of the drive units are operable at a speed of at least 4,000 rpm.

16. The drive system of claim 12, wherein the decentralized gears of the respective drive units mesh with the central gear thereof in such a way that the rotational speed of the central gear corresponds to between 0.5 times and 4.0 times the rotational speed of the respective decentralized gears.

17. The drive system of claim 16, wherein the decentralized gears of the respective drive units mesh with the central gear thereof in such a way that the rotational speed of the central gear corresponds to between 0.8 times and 3.0 times the rotational speed of the respective decentralized gears.

18. The drive system of claim 17, wherein the rotational speed of the central gear corresponds to between 1.0 and 2.5 times the rotational speed of the respective decentralized gears.

19. The drive system of claim 12, wherein the decentralized gears of the respective drive units are uniformly distributed around the circumference of the respective central gear.

20. The drive system of claim 12, wherein the central shafts of the respective drive units are operable at a speed of at least 2,000 rpm.

21. The drive system of claim 12, wherein the electric machines of the respective drive units are electric machines with a frequency converter.

22. The drive system of claim 12, wherein:
the electric machines of the respective drive units are drive motors which drive the decentralized gears; and
the coupled central shafts of the series connected drive units form an output shaft of the drive system that is configured to be coupled with a unit to be driven by the drive system.

23. The drive system of claim 22, wherein the output shaft is configured to be coupled with a compressor or a centrifugal pump.

24. The drive system of claim 12, wherein:
the electric machines of the respective drive units are generators that are drivable via the decentralized gears; and
the coupled central shafts of the series connected drive units form a drive shaft of the drive system that is configured to be coupled with a torque producing device.

25. The drive system of claim 24, wherein the drive shaft is configured to be coupled with a turbine.
